(19) United States
(12) Patent Application Publication
(10) Pub. No.: US 2020/0034927 A1
(43) Pub. Date: Jan. 30, 2020

(54) Systems and Methods for Obtaining a Mortgage Payoff Report

(71) Applicant: Finicity Corporation, Murray, UT (US)

(72) Inventors: Steven Smith, Murray, UT (US); Nicholas A. Thomas, Murray, UT (US)

(21) Appl. No.: 16/526,867

(22) Filed: Jul. 30, 2019

Related U.S. Application Data
(60) Provisional application No. 62/712,017, filed on Jul. 30, 2018.

(51) Int. Cl. G06Q 40/02; G06Q 20/10

(52) U.S. Cl. CPC G06Q 40/025; G06Q 20/102

(57) ABSTRACT

Systems and methods are presented for quickly obtaining a mortgage payoff report.

### CROSS-REFERENCE TO RELATED APPLICATIONS

This application claims the benefit of U.S. Provisional Application No. 62/712,017, filed Jul. 30, 2018.

### BACKGROUND OF THE INVENTION

### 1. Field of the Invention

The present invention relates to mortgage payoff reports, and more particularly to systems and methods for obtaining a mortgage payoff report.

### 2. Background and Related Art

Mortgage payoff reports are required when one is refinancing or selling a home. The process typically takes several days and is prone to error as many of the complicated steps are performed manually. The process usually involves the steps of the borrower requesting the report by phone or e-mail. A form is sent to the borrower from the mortgage holder for signature. This is sent to the current mortgage holder by fax or mail. The report is generated by the mortgage holder and sent back to the borrower by fax or e-mail or mail. The borrower then forwards the report to the new lender or the new lender is copied on the report if re-financing, or to a title company if selling the home. The borrower could also use the report to pay off the loan independent of a sale or re-finance.

### BRIEF SUMMARY OF THE INVENTION

Most mortgage-holding financial institutions use a mortgage servicer to manage payments, reporting and problems. Once a borrower decides they need a payoff report using the present invention, a digital authorization is generated and a payoff report request is initiated. The financial institution the borrower uses to make payments is either selected from current financial institutions in the borrower's portfolio, or if the borrower has not used the customer account permissioning process before, the financial institutions information, account information and access information is provided by the borrower. The program underlying the permissioning process (such as Finicity Connect) accesses the account and verifies access. After access to the account from which mortgage payments have been made has been verified, the digital authorization, that account information, the amount of the payment and the name of the account owner is sent through an API with the mortgage servicing company to be verified as belonging to a valid mortgage. The mortgage servicing company then calculates the payoff amount and payoff date and creates a payoff report and sends it in digital and human-readable forms to the requestor.

Implementations of the invention may provide systems, methods, and non-transitory computer-readable media for implementing methods for rapidly obtaining a mortgage payoff report. According to certain implementations of the invention, a system for rapidly obtaining a mortgage payoff report includes a borrower interface adapted to receive a mortgage payoff report request from a borrower, a digital authorization from the borrower to access one or more of the borrower's mortgage accounts at one or more financial institutions, and information providing digital access to the borrower's accounts to locate a mortgage payment amount, payment date, the name of the person making the payment, and the recipient of the mortgage payment. The system also includes an application programming interface (API) with a mortgage service provider to allow rapid digital access to verify that a valid mortgage is being serviced by the mortgage service provider corresponding to the mortgage payment amount, date, the name of the person making the payment, and the recipient of the mortgage payment, a mortgage payoff calculator used by the mortgage service provider to calculate a total amount necessary to pay off a mortgage by a certain date, and a mortgage payoff report generator adapted to generate a mortgage payoff report from information provided by the mortgage service provider and sent in digital and human-readable forms to the borrower originating the mortgage payoff report request.

In some implementations, the payoff report is also sent digitally to one or more interested third parties designated by the borrower. In some implementations, the mortgage payoff report generator is provided at the mortgage service provider. In some implementations, the mortgage payoff report generator is provided at the API. In some implementations, the borrower interface is provided by a financial services provider through an application operating on a computing device operated by the borrower. In some implementations, the borrower interface is provided by a financial services provider through a web portal accessed by a browser operating on a computing device operated by the borrower.

In some implementations, the borrower interface is further adapted to receive financial account information for non-mortgage financial accounts of the borrower. In some implementations, the system is further adapted to provide an additional borrower report such as an asset verification report, an income verification report, or an employment verification report.

According to additional implementations of the invention, a method for rapidly obtaining a mortgage payoff report includes steps of providing a borrower interface to a borrower, receiving, through the borrower interface, a request from the borrower to obtain a mortgage payoff report, receiving, through the borrower interface, a digital authorization from the borrower to obtain the mortgage payoff report from a mortgage holder or mortgage servicer, and receiving, through the borrower interface, information providing digital access to a mortgage account for the borrower at the mortgage holder or mortgage servicer. The method further includes steps of electronically contacting the mortgage holder or mortgage servicer and providing the mortgage holder or mortgage servicer with the information providing digital access to the mortgage account for the borrower, verifying that the mortgage account exists, and obtaining a calculation of a total amount necessary to pay off a mortgage associated with the mortgage account for the borrower by a certain date. The method also includes steps of generating a mortgage payoff report using the total amount necessary to pay off the mortgage and the certain date and electronically transmitting the mortgage payoff report to a recipient identified by the borrower.

In some implementations, the recipient identified by the borrower is a recipient such as the borrower, a title company, a loan officer, or a third-party financial institution. In some implementations, the information providing digital access to the mortgage account for the borrower includes a mortgage payment amount, a payment date, a name of the person making a mortgage payment, and a recipient of the mortgage payment. In some implementations, generating a mortgage payoff report is performed by the mortgage holder or mortgage servicer in response to an external request. In some implementations, the mortgage payoff report is generated by an entity providing the borrower interface from the calculation of the total amount necessary to pay of the mortgage and the certain date, which are provided by the mortgage holder or mortgage servicer.

In some implementations, the borrower interface is provided by a financial services provider through an application operating on a computing device operated by the borrower. In some implementations, the borrower interface is provided by a financial services provider through a web portal accessed by a browser operating on a computing device operated by the borrower. In some implementations, the steps are performed by an application programming interface (API) operated by a financial services provider.

In some implementations, the method further includes receiving financial account information for non-mortgage financial accounts of the borrower. In some implementations, the method further includes using the financial account information for non-mortgage financial accounts of the borrower to electronically access financial records of the non-mortgage financial accounts, using the financial records of the non-mortgage financial accounts to generate an additional borrower report selected from the group consisting of an asset verification report, an income verification report, and an employment verification report, and electronically transmitting the additional borrower report to the recipient identified by the borrower.

According to further implementations of the invention, a non-transitory computer-readable medium stores computer-readable code adapted to cause a computer system to perform a method for rapidly obtaining a mortgage payoff report. The method includes steps of providing a borrower interface to a borrower, receiving, through the borrower interface, a request from the borrower to obtain a mortgage payoff report, receiving, through the borrower interface, a digital authorization from the borrower to obtain the mortgage payoff report from a mortgage holder or mortgage servicer, and receiving, through the borrower interface, information providing digital access to a mortgage account for the borrower at the mortgage holder or mortgage servicer. The method further includes steps of electronically contacting the mortgage holder or mortgage servicer and providing the mortgage holder or mortgage servicer with the information providing digital access to the mortgage account for the borrower, verifying that the mortgage account exists, and obtaining a calculation of a total amount necessary to pay off a mortgage associated with the mortgage account for the borrower by a certain date. The method also includes steps of generating a mortgage payoff report using the total amount necessary to pay off the mortgage and the certain date and electronically transmitting the mortgage payoff report to a recipient identified by the borrower.

In some implementations, the recipient identified by the borrower is a recipient such as the borrower, a title company, a loan officer, or a third-party financial institution. In some implementations, the information providing digital access to the mortgage account for the borrower includes a mortgage payment amount, a payment date, a name of the person making a mortgage payment, and a recipient of the mortgage payment. In some implementations, generating a mortgage payoff report is performed by the mortgage holder or mortgage servicer in response to an external request. In some implementations, the mortgage payoff report is generated by an entity providing the borrower interface from the calculation of the total amount necessary to pay of the mortgage and the certain date, which are provided by the mortgage holder or mortgage servicer.

In some implementations, the borrower interface is provided by a financial services provider through an application operating on a computing device operated by the borrower. In some implementations, the borrower interface is provided by a financial services provider through a web portal accessed by a browser operating on a computing device operated by the borrower. In some implementations, the steps are performed by an application programming interface (API) operated by a financial services provider.

In some implementations, the method further includes receiving financial account information for non-mortgage financial accounts of the borrower. In some implementations, the method further includes using the financial account information for non-mortgage financial accounts of the borrower to electronically access financial records of the non-mortgage financial accounts, using the financial records of the non-mortgage financial accounts to generate an additional borrower report selected from the group consisting of an asset verification report, an income verification report, and an employment verification report, and electronically transmitting the additional borrower report to the recipient identified by the borrower.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system with which embodiments of the invention may be implemented;

FIG. 2 shows a representative networked computer system with which embodiments of the invention may be implemented;

FIG. 3 shows a representative flow chart illustrating steps of one embodiment of the invention; and

FIG. 4 shows a representative flow chart illustrating communication steps of one embodiment of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention may provide systems, methods, and non-transitory computer-readable media for implementing methods for rapidly obtaining a mortgage payoff report. According to certain embodiments of the invention, a system for rapidly obtaining a mortgage payoff report includes a borrower interface adapted to receive a mortgage payoff report request from a borrower, a digital authorization from the borrower to access one or more of the borrower's mortgage accounts at one or more financial institutions, and information providing digital access to the borrower's accounts to locate a mortgage payment amount, payment date, the name of the person making the payment, and the recipient of the mortgage payment. The system also includes an application programming interface (API) with a mortgage service provider to allow rapid digital access to verify that a valid mortgage is being serviced by the mortgage service provider corresponding to the mortgage payment amount, date, the name of the person making the payment, and the recipient of the mortgage payment, a mortgage payoff calculator used by the mortgage service provider to calculate a total amount necessary to pay off a mortgage by a certain date, and a mortgage payoff report generator adapted to generate a mortgage payoff report from information provided by the mortgage service provider and sent in digital and human-readable forms to the borrower originating the mortgage payoff report request.

In some embodiments, the payoff report is also sent digitally to one or more interested third parties designated by the borrower. In some embodiments, the mortgage payoff report generator is provided at the mortgage service provider. In some embodiments, the mortgage payoff report generator is provided at the API. In some embodiments, the borrower interface is provided by a financial services provider through an application operating on a computing device operated by the borrower. In some embodiments, the borrower interface is provided by a financial services provider through a web portal accessed by a browser operating on a computing device operated by the borrower.

In some embodiments, the borrower interface is further adapted to receive financial account information for non-mortgage financial accounts of the borrower. In some embodiments, the system is further adapted to provide an additional borrower report such as an asset verification report, an income verification report, or an employment verification report.

According to additional embodiments of the invention, a method for rapidly obtaining a mortgage payoff report includes steps of providing a borrower interface to a borrower, receiving, through the borrower interface, a request from the borrower to obtain a mortgage payoff report, receiving, through the borrower interface, a digital authorization from the borrower to obtain the mortgage payoff report from a mortgage holder or mortgage servicer, and receiving, through the borrower interface, information providing digital access to a mortgage account for the borrower at the mortgage holder or mortgage servicer. The method further includes steps of electronically contacting the mortgage holder or mortgage servicer and providing the mortgage holder or mortgage servicer with the information providing digital access to the mortgage account for the borrower, verifying that the mortgage account exists, and obtaining a calculation of a total amount necessary to pay off a mortgage associated with the mortgage account for the borrower by a certain date. The method also includes steps of generating a mortgage payoff report using the total amount necessary to pay off the mortgage and the certain date and electronically transmitting the mortgage payoff report to a recipient identified by the borrower.

In some embodiments, the recipient identified by the borrower is a recipient such as the borrower, a title company, a loan officer, or a third-party financial institution. In some embodiments, the information providing digital access to the mortgage account for the borrower includes a mortgage payment amount, a payment date, a name of the person making a mortgage payment, and a recipient of the mortgage payment. In some embodiments, generating a mortgage payoff report is performed by the mortgage holder or mortgage servicer in response to an external request. In some embodiments, the mortgage payoff report is generated by an entity providing the borrower interface from the calculation of the total amount necessary to pay of the mortgage and the certain date, which are provided by the mortgage holder or mortgage servicer.

In some embodiments, the borrower interface is provided by a financial services provider through an application operating on a computing device operated by the borrower. In some embodiments, the borrower interface is provided by a financial services provider through a web portal accessed by a browser operating on a computing device operated by the borrower. In some embodiments, the steps are performed by an application programming interface (API) operated by a financial services provider.

In some embodiments, the method further includes receiving financial account information for non-mortgage financial accounts of the borrower. In some embodiments, the method further includes using the financial account information for non-mortgage financial accounts of the borrower to electronically access financial records of the non-mortgage financial accounts, using the financial records of the non-mortgage financial accounts to generate an additional borrower report selected from the group consisting of an asset verification report, an income verification report, and an employment verification report, and electronically transmitting the additional borrower report to the recipient identified by the borrower.

According to further embodiments of the invention, a non-transitory computer-readable medium stores computer-readable code adapted to cause a computer system to perform a method for rapidly obtaining a mortgage payoff report. The method includes steps of providing a borrower interface to a borrower, receiving, through the borrower interface, a request from the borrower to obtain a mortgage payoff report, receiving, through the borrower interface, a digital authorization from the borrower to obtain the mortgage payoff report from a mortgage holder or mortgage servicer, and receiving, through the borrower interface, information providing digital access to a mortgage account for the borrower at the mortgage holder or mortgage servicer. The method further includes steps of electronically contacting the mortgage holder or mortgage servicer and providing the mortgage holder or mortgage servicer with the information providing digital access to the mortgage account for the borrower, verifying that the mortgage account exists, and obtaining a calculation of a total amount necessary to pay off a mortgage associated with the mortgage account for the borrower by a certain date. The method also includes steps of generating a mortgage payoff report using the total amount necessary to pay off the mortgage and the certain date and electronically transmitting the mortgage payoff report to a recipient identified by the borrower.

In some embodiments, the recipient identified by the borrower is a recipient such as the borrower, a title company, a loan officer, or a third-party financial institution. In some embodiments, the information providing digital access to the mortgage account for the borrower includes a mortgage payment amount, a payment date, a name of the person making a mortgage payment, and a recipient of the mortgage payment. In some embodiments, generating a mortgage payoff report is performed by the mortgage holder or mortgage servicer in response to an external request. In some embodiments, the mortgage payoff report is generated by an entity providing the borrower interface from the calculation of the total amount necessary to pay of the mortgage and the certain date, which are provided by the mortgage holder or mortgage servicer.

In some embodiments, the borrower interface is provided by a financial services provider through an application operating on a computing device operated by the borrower. In some embodiments, the borrower interface is provided by a financial services provider through a web portal accessed by a browser operating on a computing device operated by the borrower. In some embodiments, the steps are performed by an application programming interface (API) operated by a financial services provider.

In some embodiments, the method further includes receiving financial account information for non-mortgage financial accounts of the borrower. In some embodiments, the method further includes using the financial account information for non-mortgage financial accounts of the borrower to electronically access financial records of the non-mortgage financial accounts, using the financial records of the non-mortgage financial accounts to generate an additional borrower report selected from the group consisting of an asset verification report, an income verification report, and an employment verification report, and electronically transmitting the additional borrower report to the recipient identified by the borrower.

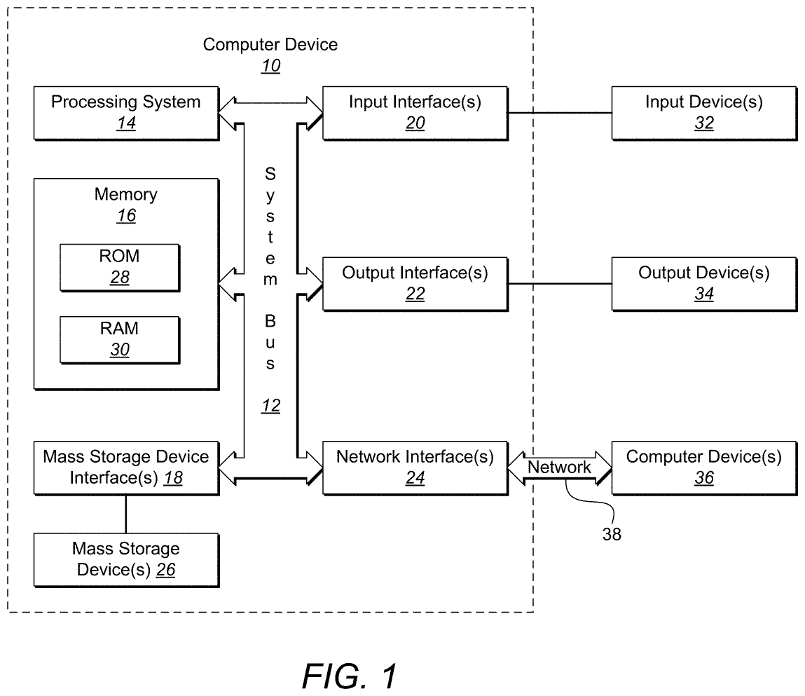

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a solid state drive, a removable solid state drive, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include solid state drives, hard disk drives, magnetic disk drives, tape drives and optical disk drives. A mass storage device 26 may read from and/or write to solid state memory, a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

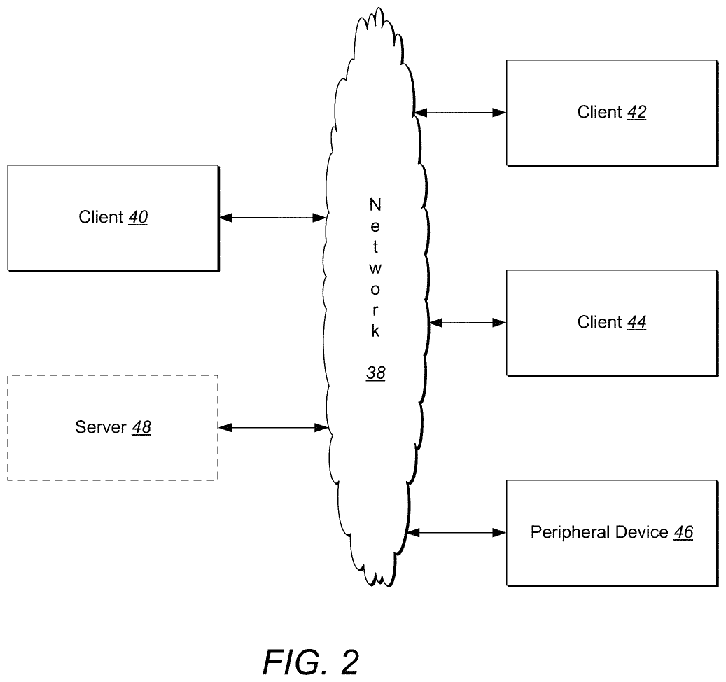

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

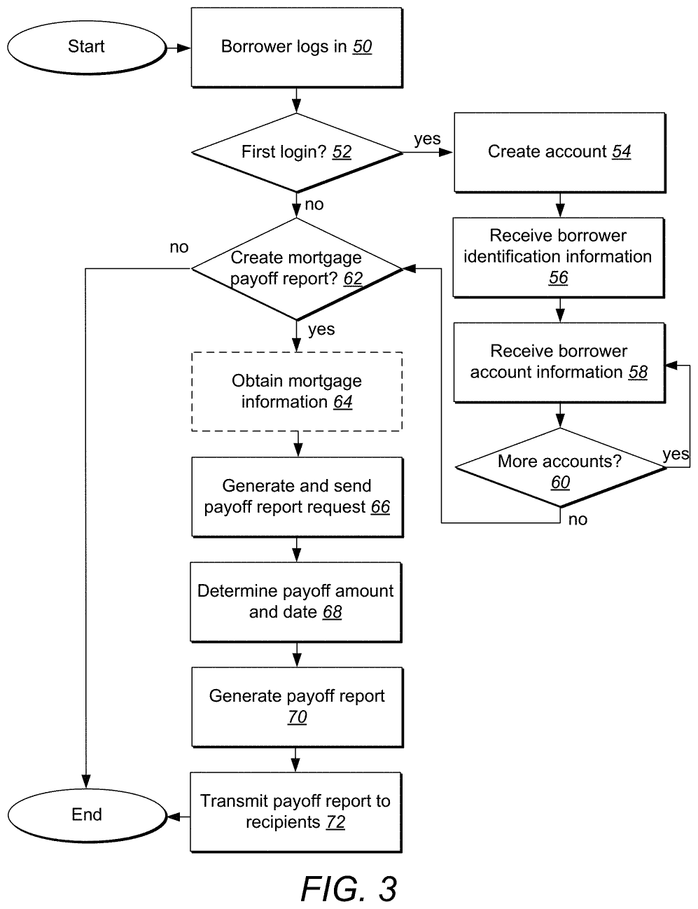

Embodiments of the invention are utilized in instances where a borrower learns that a payoff report is necessary, such as when refinancing or selling a home. Accordingly, when a borrower is informed or otherwise decides that the borrower needs a payoff report, the borrower elects to use an embodiment of the invention to request a payoff report. The payoff request may be initiated, for example, using an application or program provided by a financial services company or other provider, and the application or program may operate online and be accessed using an applicable web browsing technology. Alternatively, the application or program may be a dedicated application or program locally operated on a device (such as a mobile device) operated by the borrower. Accordingly, an exemplary process is illustrated in FIG. 3 and begins at step 50, when the borrower logs in to the application or program.

At decision block 52, in some embodiments, a determination is made as to whether the borrower already has an account with the financial services provider or other entity providing the mortgage payoff report services (e.g., whether the borrower's login is a first login). If not, execution proceeds to step 54, where a borrower account is created, using any applicable methods, including the identification of user login and password information. At step 56, the borrower may input information such as the borrower's name and other identifying information, such as address, social security number, and the like. The information received is generally sufficient information to permit identification of the borrower to the financial services company or other provider of mortgage payoff report services, as well as to allow the financial services company or other provider of mortgage payoff report services to identify the borrower to other financial institutions, in particular such institutions holding the note(s) on the borrower's mortgage(s).

At step 58, the borrower is prompted to provide information that will allow the financial services company or other provider of mortgage payoff report services to access account information relating to the borrower's financial accounts, particularly mortgage accounts, but also potentially other financial accounts. The provision of account information for other accounts may allow the financial services company or other provider of mortgage payoff report services to also generate additional reports, such as asset verification reports, income verification reports, employment verification reports, and the like. The borrower account information may include, for example, identification of financial institutions or financial institution webpages, account information, and access information (e.g., login and password information). At decision block 60, a determination can be made as to whether additional account information should be requested. If so, execution returns to step 58. If not, execution proceeds to decision block 62. Decision block 62 is also reached if the borrower is logging in to the application or program for a second or subsequent time and account information is already present. At decision block 62, a determination is made as to whether to request a mortgage payoff report. When the borrower requests the payoff report at decision block 62, the borrower typically provides information relating to the authorized recipients of the payoff report. For example, in the case of a proposed sale, the borrower designates a title company as a recipient of the payoff report. As another example, in the case of a refinance, the borrower may designate a loan officer or another financial institution as a recipient of a payoff report. The borrower may also indicate the manner in which the recipient should receive the payoff report, such as a digital report or as a human-readable report. The borrower may further indicate the manner in which the payoff report is to be delivered, such as by email, online, or by whatever method designated by the recipient.

In some embodiments, execution proceeds to step 64, where the system requests information relating to the mortgage account for use in obtaining the payoff report. Such may be necessary, for example, when the borrower has not yet provided information relating to the mortgage account at step 58, or where the information previously provided is insufficient to permit access to a mortgage payoff report from a third-party financial institution. The information obtained at step 64 may include information such as a financial institution holding the account, a mortgage account number, a name of the mortgage account owner (typically, but not always, the name of the borrower), and a mortgage payment amount. During one of steps 62-64, an authorization is received from the borrower to request the mortgage payoff report.

Once the system has sufficient information, at step 66 a digital report request with borrower authorization is generated representing the borrower's payoff report request, and the report request is transmitted to the financial institution or mortgage servicing company holding the mortgage account. The financial institution or mortgage servicing company uses the information contained in the request to verify the account. If the account cannot be verified, execution may return to step 64 to allow the borrower to verify that correct information was provided. Once the account has been verified, the financial institution or mortgage servicing company determines the payoff amount and payoff date (the date by which payment must be made for the payoff amount to be valid) at step 68.

The payoff amount and payoff date is used at step 70 to generate a mortgage payoff report in either digital (machine-readable) or human-readable form. This step may be performed either by the financial institution or mortgage services provider, or the payoff amount and payoff date may be transmitted back to the requesting financial services provider or other provider providing the mortgage payoff report services, and that provider may use the payoff amount and payoff date to generate the mortgage payoff report. Where the holding financial institution or mortgage services provider generates the payoff report, the financial institution or mortgage services provider transmits the report back to the requesting financial services provider or other provider, such as to an application programming interface (API) operated by the financial services provider or other provider, using network or other communications resources.

Once the financial services provider or other provider has the applicable payoff report, it then transmits the payoff report to the designated recipient or recipients using the designated transmission methods (e.g., human-readable or digital (machine-readable) format, email vs. API-to-API portal, etc.) at step 72, after which execution of the method ends. As may be appreciated, the process may be significantly more rapid and secure than prior methods for obtaining a mortgage payoff report, especially in instances where insufficient or incorrect mortgage account information is originally received from the borrower. Incorrect information can be identified in real time and corrected at the point in time at which the borrower is requesting the mortgage payoff report. Because the mortgage payoff report (or payoff information) is transmitted directly from the mortgage services provider through the API and then from the API on to the recipients without being transmitted to the borrower, the possibility of fraud is greatly reduced, and payoff report recipients can be confident in relying upon the received reports.

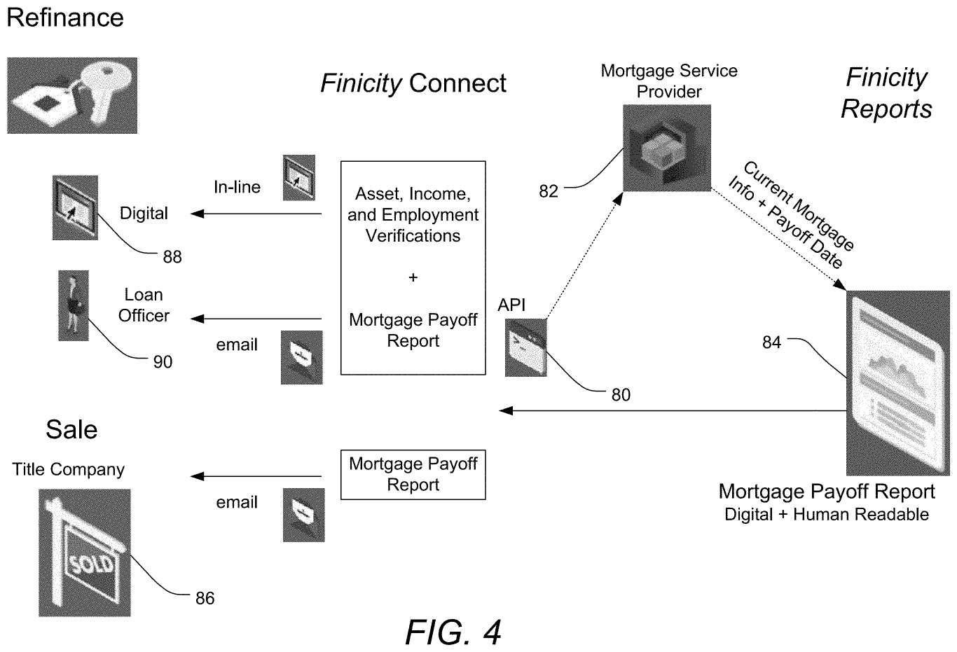

FIG. 4 illustrates an embodiment of the invention in an alternate manner. Once a borrower decides they need a payoff report using embodiments of the present invention, a digital authorization is generated and a payoff report request is initiated at an API 80. The bank the borrower uses to make payments is either selected from current financial institutions in the borrower's portfolio, or if the borrower has not used the customer account permissioning process before, the bank information, account information and access information is provided by the borrower. The program underlying the permissioning process (such as Finicity Connect) accesses the account from a mortgage service provider 82 or other mortgage servicing company and verifies access. As seen in FIG. 4, after access to the account from which mortgage payments have been made has been verified, the digital authorization, that account information, the amount of the payment and the name of the account owner is sent through an API with the mortgage service provider 82 to be verified as belonging to a valid mortgage. The mortgage servicing company then calculates the payoff amount and payoff date and either creates a payoff report 84 and sends it in digital and human-readable forms to the requestor, or sends the information to the Finicity Connect program through the API 80, and Finicty Connect produces the payoff report 84 and sends it to the requestor. The report may be branded to show the name of the financial institution with which the mortgage was initiated.

If the mortgage service provider 82 is unable to recognize an existing mortgage from the information sent, a query for more information is sent to the requestor. This may be required because of a name mismatch between the account holder and the borrower or other mismatched information. A second batch of new information is then sent through the API 80 to the mortgage service provider 82 to attempt to match the data with an existing mortgage. When successful, a payoff report 84 is generated and sent to the requestor, a title company 86, a new lender (e.g., a digital recipient 88 or a loan officer 90) if refinancing, or the information may be sent to Finicity Connect to be used to generate a payoff report and then forwarded to the requestor or authorized third parties.

This entire process is encrypted, and digital, with rapid access through the API 80 with the mortgage service provider 82. An average report 84 can be generated in a few minutes instead of the several day process of getting a payoff report currently. Since the data is not touched by several humans as in the current process, the inventive method is also more accurate and less prone to error. An additional benefit is that the process is less prone to fraud as the account information is verified with the financial institution from which the payments are made and restrictive personal access information is required.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A system for rapidly obtaining a mortgage payoff report comprising:
a borrower interface adapted to receive:
a mortgage payoff report request from a borrower;
a digital authorization from the borrower to access one or more of the borrower's mortgage accounts at one or more financial institutions; and
information providing digital access to the borrower's accounts to locate a mortgage payment amount, payment date, the name of the person making the payment, and the recipient of the mortgage payment;
an application programming interface (API) with a mortgage service provider to allow rapid digital access to verify that a valid mortgage is being serviced by the mortgage service provider corresponding to the mortgage payment amount, date, the name of the person making the payment, and the recipient of the mortgage payment;
a mortgage payoff calculator used by the mortgage service provider to calculate a total amount necessary to pay off a mortgage by a certain date; and
a mortgage payoff report generator adapted to generate a mortgage payoff report from information provided by the mortgage service provider and sent in digital and human-readable forms to the borrower originating the mortgage payoff report request.

2. The system as recited in claim 1, wherein the payoff report is also sent digitally to one or more interested third parties designated by the borrower.

3. The system as recited in claim 1, wherein the mortgage payoff report generator is provided at the mortgage service provider.

4. The system as recited in claim 1, wherein the mortgage payoff report generator is provided at the API.

5. The system as recited in claim 1, wherein the borrower interface is provided by a financial services provider through an application operating on a computing device operated by the borrower.

6. The system as recited in claim 1, wherein the borrower interface is provided by a financial services provider through a web portal accessed by a browser operating on a computing device operated by the borrower.

7. The system as recited in claim 1, wherein the borrower interface is further adapted to receive financial account information for non-mortgage financial accounts of the borrower.

8. The system as recited in claim 7, wherein the system is further adapted to provide an additional borrower report selected from the group consisting of an asset verification report, an income verification report, and an employment verification report.

9. A method for rapidly obtaining a mortgage payoff report comprising:
providing a borrower interface to a borrower;
receiving, through the borrower interface, a request from the borrower to obtain a mortgage payoff report;
receiving, through the borrower interface, a digital authorization from the borrower to obtain the mortgage payoff report from a mortgage holder or mortgage servicer;
receiving, through the borrower interface, information providing digital access to a mortgage account for the borrower at the mortgage holder or mortgage servicer;
electronically contacting the mortgage holder or mortgage servicer and providing the mortgage holder or mortgage servicer with the information providing digital access to the mortgage account for the borrower;
verifying that the mortgage account exists;
obtaining a calculation of a total amount necessary to pay off a mortgage associated with the mortgage account for the borrower by a certain date;
generating a mortgage payoff report using the total amount necessary to pay off the mortgage and the certain date; and
electronically transmitting the mortgage payoff report to a recipient identified by the borrower.

10. The method as recited in claim 9, wherein the recipient identified by the borrower comprises a recipient selected from the group consisting of the borrower, a title company, a loan officer, and a third-party financial institution.

11. The method as recited in claim 9, wherein the information providing digital access to the mortgage account for the borrower comprises a mortgage payment amount, a payment date, a name of the person making a mortgage payment, and a recipient of the mortgage payment.

12. The method as recited in claim 9, wherein generating a mortgage payoff report is performed by the mortgage holder or mortgage servicer in response to an external request.

13. The method as recited in claim 9, wherein the mortgage payoff report is generated by an entity providing the borrower interface from the calculation of the total amount necessary to pay of the mortgage and the certain date, which are provided by the mortgage holder or mortgage servicer.

14. The method as recited in claim 9, wherein the borrower interface is provided by a financial services provider through an application operating on a computing device operated by the borrower.

15. The method as recited in claim 9, wherein the borrower interface is provided by a financial services provider through a web portal accessed by a browser operating on a computing device operated by the borrower.

16. The method as recited in claim 9, wherein the steps are performed by an application programming interface (API) operated by a financial services provider.

17. The method as recited in claim 9, further comprising receiving financial account information for non-mortgage financial accounts of the borrower.

18. The method as recited in claim 17, further comprising:
using the financial account information for non-mortgage financial accounts of the borrower to electronically access financial records of the non-mortgage financial accounts;
using the financial records of the non-mortgage financial accounts to generate an additional borrower report selected from the group consisting of an asset verification report, an income verification report, and an employment verification report; and
electronically transmitting the additional borrower report to the recipient identified by the borrower.

19. A non-transitory computer-readable medium storing computer-readable code adapted to cause a computer system to perform a method for rapidly obtaining a mortgage payoff report, the method comprising:
providing a borrower interface to a borrower;
receiving, through the borrower interface, a request from the borrower to obtain a mortgage payoff report;
receiving, through the borrower interface, a digital authorization from the borrower to obtain the mortgage payoff report from a mortgage holder or mortgage servicer;
receiving, through the borrower interface, information providing digital access to a mortgage account for the borrower at the mortgage holder or mortgage servicer;
electronically contacting the mortgage holder or mortgage servicer and providing the mortgage holder or mortgage servicer with the information providing digital access to the mortgage account for the borrower;
verifying that the mortgage account exists;
obtaining a calculation of a total amount necessary to pay off a mortgage associated with the mortgage account for the borrower by a certain date;
generating a mortgage payoff report using the total amount necessary to pay off the mortgage and the certain date; and
electronically transmitting the mortgage payoff report to a recipient identified by the borrower.

20. The non-transitory computer-readable medium as recited in claim 19, wherein the information providing digital access to the mortgage account for the borrower comprises a mortgage payment amount, a payment date, a name of the person making a mortgage payment, and a recipient of the mortgage payment.
